(19) United States
(12) Patent Application Publication
(10) Pub. No.: US 2025/0024233 A1
(43) Pub. Date: Jan. 16, 2025

(54) ESTABLISHING LOCAL CONNECTIVITY BETWEEN DEVICES AND APPLICATIONS IN PRIVATE CLOUD ENVIRONMENT

(71) Applicants: Koninklijke KPN N.V., Rotterdam (NL); Nederlandse Organisatie Voor Toegepast-Natuurwetenschappelijk Onderzoek TNO, 's-Gravenhage (NL)

(72) Inventors: Toni Dimitrovski, Boskoop (NL); Lucia D'Acunto, Delft (NL); Jan-Willem Martin Kleinrouweler, Pijnacker (NL)

(21) Appl. No.: 18/714,985

(22) PCT Filed: Nov. 25, 2022
(86) PCT No.: PCT/EP2022/083240

§ 371 Date: May 30, 2024

(30) Foreign Application Priority Data
Dec. 1, 2021 (EP) 21211804.6

(51) Int. Cl. H04W 4/50; H04L 41/0806; H04W 64/00; H04W 76/10; H04W 88/08

(52) U.S. Cl. CPC H04W 4/50; H04L 41/0806; H04W 64/003; H04W 76/10; H04W 88/085

(57) ABSTRACT

Network functions are described to establish local connectivity between a device of a telecommunications network and an application instantiated a private cloud environment. The local connectivity may be established by providing, in the private cloud environment, a subdomain for use by the telecommunications network, wherein the subdomain may be manageable via an external control endpoint. A network orchestration function of the telecommunications network may, based on information received from a service orchestrator for the private cloud environment, initiate deployment of one or more network functions in the subdomain of the private cloud environment, and configure the one or more deployed network functions to allow the user plane communication between the device and the application to be established. Such local connectivity may be advantageous in terms of performance and address privacy and control concerns, which may otherwise occur if the application data traffic between the device and the application is routed via a core network of the telecommunications network.

### TECHNICAL FIELD

The invention relates to a computer-implemented method and to a network node or system of network nodes configured for implementing a network orchestration function in a telecommunications network to assist in establishing local connectivity between a device and an application via a private cloud environment. The invention further relates to a computer-implemented method and to a network node or system of network nodes configured for implementing a service orchestrator in the private cloud environment, wherein the service orchestrator is configured to assist in establishing local connectivity between the device and the application via the private cloud environment. The invention further relates to a local area network comprising the service orchestrator, to a telecommunications network comprising the network orchestration function, and to a computer-readable medium comprising data for causing a processor system to perform any of the computer-implemented methods.

### BACKGROUND

Clouds are widely used to store and manage data, run applications, deliver content or services, etc. Here, the term ‘cloud’ may refer to a network of nodes, typically servers, which may be jointly configured to operate as a single environment to offer the aforementioned functionality (and which cloud may therefore also be referred to as a ‘cloud environment’). Public clouds may share resources and deliver content or services to the public, for example over the Internet. Examples of such public clouds include hyperscale clouds such as Amazon AWS, Google Cloud Platform and Microsoft's Azure, but also various types of smaller ‘non-hyperscale’ public clouds.

Increasingly, private clouds are being deployed over private internal networks at enterprises or factory locations, e.g., over so-called on-premises local area networks. Such private clouds may offer more privacy and/or more control over privacy compared to a public cloud. Another reason for the deployment of private clouds is that an operator of such a private cloud may maintain ownership of, and thus control over, the infrastructure behind the private cloud. Yet another reason may be that public clouds can be conveniently reachable by devices via the Internet, but services offered via the Internet may represent ‘best effort’ services as such service delivery via the Internet may not provide guarantees in terms of connection quality, bandwidth, latency and/or provide transparent performance which some enterprises may require.

It is known to combine a private cloud with a public cloud. Such a cloud may also be referred to as a ‘hybrid cloud’. For example, it is known for some operators of hyperscale public clouds to provide local on-site edge nodes (also in short ‘edges’) with connectivity to local devices being provided using private wide area networks such as 4G and 5G. For example, Amazon AWS offers AWS Outposts [1] which are said to be combinable with private 5G networks to enable enterprise applications, which may need to remain on-premises for business, legal, and/or technical reasons, to be deployed in a local cloud environment. It is said that AWS functionality such as autoscaling, orchestration, monitoring, and identity and access management may be provided in an AWS outpost and may work as it works in an AWS regional cloud.

AWS Outposts and similar hybrid cloud solutions thus effectively extend a hyperscale public cloud to a local outpost while retaining control over the local outpost. This way, an enterprise may still get some of the benefits of not connecting over the Internet, but require the enterprise applications and services to run on or in the cloud's outpost and thus outside of the enterprise's direct control. Another disadvantage may be that such hybrid cloud solutions may be proprietary, in that they may be specific for a particular cloud operator. Such proprietary hybrid cloud solutions may be disadvantageous as they may hinder mobility across cloud operators, prompting initiatives such as [2] to promote openness and federation instead of proprietary and centralized solutions in order to ease of mobility across cloud operators.

As opposed to hyperscale public cloud operators, telecommunication network operators may provide for standardization in their telecommunications networks, for example in terms of network interfaces, network functions, etc. It is known for telecommunication network operators to provide cloud computing services to customers, for example to be used by devices of the customer, which devices may be configured to connect to the telecommunications network. A specific example is that robotic systems in a factory may be provided with 5G connectivity and may communicate with an application service hosted in the 5G telecommunication network's cloud. For example, the application service may be configured to analyze sensor data of the robotic systems and control the robotic systems based on the analysis result.

It is known for a telecommunication network to be able to instantiate network functions for customers to provide such application services, for example using the ETSI Network Function Virtualization (NFV) set of specifications [3]. However, such instantiation of network functions typically happens in a cloud environment in the telecommunications network, rather than in a private cloud environment as may be desired by enterprises. Accordingly, application data may have to be sent by local devices to, and received from, a core network of the telecommunications network and thereby through a non-private cloud environment, which may be disadvantageous in terms of performance but may also be undesirable for other reasons, e.g., for an enterprise to maintain privacy or control.

### REFERENCES

[1] ‘Private Mobile Edge Computing and 5G’, retrievable via https://d1.awsstatic.com/Wavelength2020/AWS-Private-Mobile-Edge-Computing-and-5G-Final-Mar2021.pdf
[2] ‘GAIA-X Technical Architecture’, retrievable via https://www.bmwi.de/Redaktion/EN/Publikationen/gaia-x-technical-architecture.pdf? blob=publicationFile&v=7
[3] ETSI GS NFV-IFA 030 V3.1.1 (2018 September), Network Functions Virtualisation (NFV) Release 3; Management and Orchestration; Multiple Administrative Domain; Aspect Interfaces Specification

### SUMMARY

It may be desirable for an enterprise to be able to host an application in a private cloud environment and to have local devices, which are capable of connecting to the telecommunications network, communicate with the application more directly, e.g., without application data exchanged between the devices and the application having to be transported via a core network of the telecommunications network.

In a first aspect of the invention, a method may be provided for establishing local connectivity between a device and an application via a private cloud environment. The application may be instantiated in the private cloud environment. The device may be capable of connecting to a telecommunications network and communicating via a user plane of the telecommunications network. The method may comprise:
providing, in the private cloud environment, a subdomain for use by the telecommunications network, wherein the subdomain may be provided with an external application endpoint for the application in the private cloud environment and with an external access endpoint for the device and may be manageable via an external control endpoint;
by a service orchestrator in the private cloud environment, providing information to a network orchestration function of the telecommunications network, which information may comprise or may be indicative of at least the external control endpoint, the external application endpoint and the external access endpoint;
by the network orchestration function:
   initiating deployment of one or more network functions in the subdomain of the private cloud environment using the external control endpoint, thereby obtaining one or more deployed network functions, wherein the one or more deployed network functions may support user plane communication between the device and the application via the subdomain;
   configuring the one or more deployed network functions using the external application endpoint and the external access endpoint to allow the user plane communication between the device and the application to be established via the one or more deployed network functions.

In a further aspect of the invention, a network node or system of network nodes may be configured to implement a network orchestration function in a telecommunications network to assist in establishing local connectivity between a device and an application via a private cloud environment. The application may be instantiated in the private cloud environment. The device may be capable of connecting to the telecommunications network and communicating via a user plane of the telecommunications network. The network node or system of network nodes may comprise:
a network interface;
a processing subsystem which may be configured to, via the network interface:
   receive, from a service orchestrator in the private cloud environment, information which may comprise or may be indicative of:
   i) an external control endpoint of a subdomain provided in the private cloud environment, wherein the subdomain may be manageable via the external control endpoint;
   ii) an external application endpoint provided in the subdomain for the application in the private cloud environment; and
   iii) an external access endpoint provided in the subdomain for the device;
initiate deployment of one or more network functions in the subdomain of the private cloud environment using the external control endpoint, thereby obtaining one or more deployed network functions, wherein the one or more deployed network functions may support user plane communication between the device and the application via the subdomain; and
configure the one or more deployed network functions using the external application endpoint and the external access endpoint to allow the user plane communication between the device and the application to be established via the one or more deployed network functions.

In a further aspect of the invention, a computer-implemented method may be provided for assisting in establishing local connectivity between a device and an application via a private cloud environment. The application may be instantiated in the private cloud environment. The device may be capable of connecting to a telecommunications network and communicating via a user plane of the telecommunications network. The method may comprise, at a network node or a system of network nodes in the telecommunications network:
receiving, from a service orchestrator in the private cloud environment, information which may comprise or may be indicative of:
   i) an external control endpoint of a subdomain provided in the private cloud environment, wherein the subdomain is manageable via the external control endpoint;
   ii) an external application endpoint provided in the subdomain for the application in the private cloud environment; and
   iii) an external access endpoint provided in the subdomain for the device;
initiating deployment of one or more network functions in the subdomain of the private cloud environment using the external control endpoint, thereby obtaining one or more deployed network functions, wherein the one or more deployed network functions may support user plane communication between the device and the application via the subdomain; and
configuring the one or more deployed network functions using the external application endpoint and the external access endpoint to allow the user plane communication between the device and the application to be established via the one or more deployed network functions.

In a further aspect of the invention, a network node or system of network node may be configured to implement a service orchestrator for a private cloud environment. The service orchestrator may be configured to assist in establishing local connectivity between a device and an application via the private cloud environment. The application may be instantiated in the private cloud environment. The device may be capable of connecting to a telecommunications network and communicating via a user plane of the telecommunications network. The network node or system of network nodes may comprise:
a network interface;
a processing subsystem which may be configured to, via the network interface, provide information to a network orchestration function in the telecommunications network, wherein the information may comprise or may be indicative of:
   i) an external control endpoint of a subdomain provided in the private cloud environment, wherein the subdomain may be manageable via the external control endpoint;
   ii) an external application endpoint provided in the subdomain for the application in the private cloud environment; and
   iii) an external access endpoint provided in the subdomain for the device;
   to enable the network orchestration function to initiate deployment of one or more network functions in the subdomain of the private cloud environment using the external control endpoint, thereby obtaining one or more deployed network functions, wherein the one or more deployed network functions may support user plane communication between the device and the application via the subdomain, and to configure the one or more deployed network functions using the external application endpoint and the external access endpoint to allow the user plane communication between the device and the application to be established via the one or more deployed network functions.

In a further aspect of the invention, a computer-implemented method may be provided for assisting in establishing local connectivity between a device and an application via a private cloud environment. The application may be instantiated in the private cloud environment. The device may be capable of connecting to a telecommunications network and communicating via a user plane of the telecommunications network. The method may comprise, at a network node or a system of network nodes in a local area network which hosts the private cloud environment:
providing information to a network orchestration function in the telecommunications network, wherein the information may comprise or may be indicative of:
   i) an external control endpoint of a subdomain provided in the private cloud environment, wherein the subdomain is manageable via the external control endpoint;
   ii) an external application endpoint provided in the subdomain for the application in the private cloud environment; and
   iii) an external access endpoint provided in the subdomain for the device;
   to enable the network orchestration function to initiate deployment of one or more network functions in the subdomain of the private cloud environment using the external control endpoint, thereby obtaining one or more deployed network functions, wherein the one or more deployed network functions may support user plane communication between the device and the application via the subdomain, and to configure the one or more deployed network functions using the external application endpoint and the external access endpoint to allow the user plane communication between the device and the application to be established via the one or more deployed network functions.

In a further aspect of the invention, a transitory or non-transitory computer-readable medium may be provided comprising data representing a computer program. The computer program may comprise instructions for causing a processor system to perform any given computer-implemented method described in this specification.

The above measures may involve an on-premises network in the form of a local area network which may be configured to host a private cloud environment. Such a private cloud environment may be known per se and may be characterized by, for example, the presence of a virtualized infrastructure manager (VIM) or similar entity. The private cloud environment may for example be hosted by an enterprise, for example at a site of the enterprise, e.g., at a factory, an office, a store, etc. In the private cloud environment, applications may be instantiated, for example to provide services to devices of the enterprise, such as for example robotic systems or other manufacturing equipment. Such services may thereby be considered as (private) cloud services. The application may for example be instantiated by a service orchestrator for the private cloud environment, which service orchestrator may also be known as a ‘cloud orchestrator’. The devices themselves may be configured to connect to a telecommunications network, for example via radio-based communication. In a specific example, the devices may be so-called user equipment (UE) of a 5G or later-generation mobile telecommunications network. Accordingly, devices may be provisioned and to a degree controlled by the telecommunications network, and may therefore also be referred to as devices ‘of the telecommunications network.

To enable the devices to communicate with an application in the private cloud environment, a subdomain may be provided in the private cloud environment. Such a subdomain may be an administrative subdomain, and may be established in any known manner, for example by manual configuration steps. The subdomain may be controllable via an external control endpoint from outside of the subdomain. Here, the term ‘external control endpoint’ may refer to an external endpoint to be used for control of the subdomain. The adjective ‘external’ may here and elsewhere refer to an endpoint being accessible from outside of the subdomain, while the adjective ‘control’ may be understood as representing a label indicating the external endpoint's intended use, being in this case the control of the subdomain. Such control may for example include the ability to instantiate network functions in the subdomain, or in general the ability to administratively control the subdomain. In particular, the service orchestrator may be configured to provide the telecommunications network with such control over the subdomain. Namely, the service orchestrator may be configured to provide information on the external control endpoint of the subdomain to a network orchestration function in the telecommunications network. Such information may for example include data which specifies the external control endpoint, or information which allows the external control endpoint to be identified, such as an IP address, IP address and port number, URL, URL and Tenant ID, etc.

Having identified the external control endpoint, the network orchestration function in the telecommunications network may initiate deployment of one or more network functions in the subdomain of the private cloud environment via the external control endpoint. The network function(s) to be deployed may include network functions which support user plane communication between devices and applications. Such network functions may be used within the telecommunications network to allow user plane communication between devices and applications. In other words, such network functions may be normally instantiated in the telecommunications network itself, for example to allow the devices of the enterprise to communicate with other entities.

Having deployed these network functions in the subdomain, e.g., by instantiating such network functions from a repository, the deployed network functions may be configured to allow local connectivity between a device of the enterprise and the application instantiated in its private cloud environment to be established. For that purpose, in addition to providing information about the external control endpoint to the network orchestration function, the service orchestrator may also provide an external application endpoint to the network orchestration function, which external application endpoint may be used to reach the application in the private cloud from the subdomain. It will be appreciated that in the term ‘external application endpoint’, the adjective ‘application’ may be represent a label indicating the external endpoint's intended use. In addition, an external access endpoint may be provided by the service orchestrator to the network function orchestrator. The external access endpoint may be an endpoint for an access point used by the device, such as for example a remote radio unit (RRU) to which the device may be connected. It will be appreciated that in the term ‘external access endpoint’, the adjective ‘access’ may be understood as representing a label indicating the external endpoint's intended use, namely to connect to an access point.

By providing both the external access endpoint and the external application endpoint to the network function orchestrator, the network function orchestrator may configure the deployed network function(s) with the external application endpoint and the external access endpoint to allow user plane communication between the device and the application to be established via the one or more deployed network functions. This way, at least one of the deployed network functions (e.g., a user plane function, UPF) within the subdomain may be able to establish connectivity with the application, while at least one of the deployed network functions (e.g., an gNB-CU/DU) may be able to establish connectivity with the access point. When the device subsequently sends a connection request via the subdomain to the network, the network may request the one or more deployed network functions to forward packets from the device to the application and vice versa. In addition, the network function orchestrator may configure parts of its network, for example the access point (e.g., eNB, gNB, WiFi access point, remote radio unit or a fixed access switch) and/or part of a transport network leading to the access point, to route application data traffic from the device to the subdomain, or from the subdomain to the device, via the external access endpoint. Such application data traffic may then be transported via the external access endpoint to the subdomain and via the user plane within the subdomain and via the external application endpoint to the application instantiated in the private cloud environment. Thereby, local connectivity may be established between the device and the application, with ‘local’ referring to connectivity which does not rely on the data being transported via a core network of the telecommunications network.

In accordance with the above measures, an owner of the private cloud environment (this being in the following, by way of example, an enterprise) may relinquish control of a limited part of its private cloud environment to a telecommunications network which provides connectivity to the enterprise's devices, namely to a (n) (administrative) subdomain within the private cloud environment. By relinquishing such control, the telecommunications network may deploy network functions locally within the private cloud environment, i.e., within the subdomain, to support user plane communication to and from devices of the telecommunications network, which network functions would otherwise have to be instantiated in the telecommunications network itself. In the latter case, traffic between devices of the telecommunications network and the application in the enterprise's private cloud environment would have to be routed entirely via the telecommunications network, e.g., via a core network of the telecommunications network. By instantiating such network functions locally in the subdomain, part of the functionality of the telecommunications network may be reproduced locally, and as such, the telecommunications network may be enabled to route traffic between the device and the application more directly. Effectively, this may result in a ‘hybrid’ cloud environment, here referring to a combination of the private cloud environment and network functions which are deployed in the subdomain and tied to the network operator's cloud environment.

An advantage of such routing of traffic may be that the service performance may be improved, e.g., in terms of bandwidth, latency, jitter, etc., in that the application data traffic may be more directly routed between the device and the application. At the same time, administrative divisions between the enterprise and the operator of the telecommunications network may be maintained. Namely, the enterprise may continue to own and manage its applications and network infrastructure, while the operator of the telecommunications network (also elsewhere referred to ‘network operator’) may exclusively control the network functions deployed in the subdomain so that the border between the domains (i.e., the domain of the private cloud environment and that of the telecommunications network) may be preserved. Both administrative domains may thus not need to be subordinates of each other but may represent equal level administrative domains which may function collaboratively. This division between the administrative domains may address concerns on privacy, ownership, and control, both from the enterprise and network operator's side. Yet another advantage may be that the network functions deployed in the subdomain may be of a same type as elsewhere deployed in the telecommunications network. This may provide service continuity for devices when moving to a different location, for example a location remote from the private cloud environment, in which case the device's connectivity may be simply reconfigured to make use of the network functions deployed in the telecommunications network. Yet another advantage may be that network functions of telecommunications networks are normally standardized, at least in terms of their interfaces. This may facilitate an enterprise changing from one network operator to another, as another network operator may simply deploy its network functions in the subdomain in place of a previous network operator's network functions, without requiring an entirely different connectivity solution. Yet another advantage may be that the enterprise may not need to have operational network knowledge and infrastructure (virtual or containerized network functions) within the organization itself or may not need to request such infrastructure from an network operator as an Infrastructure (or Platform)-as-a-Service (laaS, PaaS) but rather follow the Software-as-a-Service model where the software is provided by the network operator (the software being the network functions) and the infrastructure by the enterprise (the infrastructure being here the private cloud environment).

The following embodiments may represent embodiments of the network node or system of network nodes configured for, and corresponding computer-implemented method of, implementing a network orchestration function in a telecommunications network, but may, unless otherwise precluded for technical reasons, also indicate corresponding embodiments of the network node or system of network nodes for, and corresponding computer-implemented method of, implementing a service orchestrator for a private cloud environment. In particular, any functionality described to be performed at or by the network orchestration function may imply the service orchestrator being configured to perform the respective functionality or the corresponding method to comprise a step of performing the respective functionality. Likewise, any functionality described to be performed at or by the service orchestrator may imply the network orchestration function being configured to perform the respective functionality or the corresponding method to comprise a step of performing the respective functionality. Any functionality described without specific reference to the network orchestration function, or the service orchestrator may be performed by the network orchestration function or the service orchestrator or both jointly.

In an embodiment, the processing subsystem may be configured to:
receive, from the service orchestrator, information which may comprise or be indicative of an external connectivity endpoint of the subdomain;
establish connectivity between the one or more deployed network functions in the subdomain and one or more other network functions in the telecommunications network using the external connectivity endpoint.

It may be desirable for the deployed network functions to be able to communicate with other network functions in the telecommunications network, for example network functions which have a centralized role within the telecommunications network. For that purpose, an external connectivity endpoint may be provided in the subdomain, and information on the external connectivity endpoint may be provided by the service orchestrator to the network function orchestrator. It will be appreciated that in the term ‘external connectivity endpoint’, the adjective ‘connectivity’ may be understood as representing a label indicating the external endpoint's intended use. The network function orchestrator may in turn establish connectivity between the one or more deployed network functions in the subdomain and one or more other network functions in the telecommunications network using the external connectivity endpoint. For example, in an embodiment, the one or more other network functions may include at least one of: a session management function (SMF), and an access and mobility management function (AMF). This way, the network functions deployed in the subdomain may communicate with the telecommunications network's SMF and/or AMF, without such an SMF or AMF having to be instantiated in the subdomain itself.

In an embodiment, the processing subsystem may be configured to establish the connectivity between the one or more deployed network functions in the subdomain and the one or more other network functions in the telecommunications network by requesting a wide area network infrastructure manager (WIM) of the telecommunications network to collaboratively establish said connectivity in collaboration with a wide area network infrastructure manager (WIM) of the private cloud environment. Such a wide area network infrastructure manager may be known per se and may be used to establish connectivity with other networks. By establishing the connectivity between the network function(s) in the subdomain and the network functions in the telecommunications network using such wide area network infrastructure managers, a standardized way to establish connectivity may be (re) used.

In an embodiment, the device may be configured to connect to a remote radio unit (RRU) of the telecommunications network, wherein the processing subsystem may be configured to establish connectivity between the remote radio unit and the external access endpoint of the subdomain to enable the device to connect to the subdomain via the remote radio unit. A remote radio unit may be an example of an access point as described elsewhere. By establishing connectivity between the remote radio unit and the external access endpoint, for example by reconfiguring the remote radio unit and/or part of a transport network towards the remote radio unit to route application data traffic via the external access endpoint, local connectivity between the device and the application may be established.

In an embodiment, the processing subsystem may be configured to establish the connectivity between the remote radio unit and the external access endpoint of the subdomain using a wide area network infrastructure manager (WIM) of the telecommunications network. Such a wide area network infrastructure manager may be known per se and may be used to establish connectivity with other networks. By establishing the connectivity between the subdomain and the access point, e.g., the remote radio unit, to which the device is connected using such a wide area network infrastructure manager, a standardized way to establish connectivity may be (re) used.

In an embodiment, the processing subsystem may be configured to:
receive, from the service orchestrator, geolocation information indicative of a geolocation of the device; and
identify between which remote radio unit and the external access endpoint connectivity is to be established by, based on the geolocation information, identifying a remote radio unit which is in a geographical vicinity of the device.

The network function orchestrator may identify to which remote radio unit the device is connected, or is likely to connect, based on geolocation information received from the service orchestrator. Such geolocation information may take any suitable form, such as a street address, a geolocation coordinate, etc. Accordingly, the network function orchestrator may arrange for application data traffic to be routed from the remote radio unit to which the device is connected, or is likely to connect, to the subdomain, even if the remote radio unit is not in another way attributed to the enterprise, e.g., by the remote radio unit being located on the enterprises' premises. Advantageously, by providing the geolocation information to the network orchestration function, so-called ‘shared’ remote radio units, which may be ‘shared’ as they be utilized, but not exclusively, by devices of the enterprise, may be identified and reconfigured to route the device's application data traffic to the subdomain.

In an embodiment, the processing subsystem may be configured to:
receive, from the service orchestrator, a request for policy control;
in response to the request, expose one or more policy control functions of the telecommunications network to be accessed from the private cloud environment.

The telecommunications network may provide functionality for policy control, for example using a policy control function. By exposing the policy control function(s) to be accessible from the private cloud environment, the enterprise may be able to control policy rules such as quality of service for the application data traffic of its devices, but without gaining access to other network functions of the telecommunications network. In other words, the enterprise may be provided with selective access to policy control for its application data, while otherwise maintaining the administrative divisions between the enterprise and the network operator.

In an embodiment, the one or more deployed network functions may include at least one of: a user plane function (UPF), a gNodeB centralized unit (gNB-CU) function, and a gNodeB distributed unit (gNB-DU) function.

In an embodiment, the network orchestration function implemented by the network node or system of network nodes may be a network functions virtualization orchestrator (NFVO) or a combination of the network functions virtualization orchestrator and a network support system (OSS/BSS). An example of a network support system is an operator support system (OSS) or business support system.

The following embodiments may represent embodiments of the network node or system of network nodes configured for, and corresponding computer-implemented method of, implementing a service orchestrator for a private cloud environment, but may, unless otherwise precluded for technical reasons, also indicate corresponding embodiments of the network node or system of network nodes for, and corresponding computer-implemented method of, implementing a network orchestration function in a telecommunications network. In particular, any functionality described to be performed at or by the service orchestrator may imply the network orchestration function being configured to perform the respective functionality or the corresponding method to comprise a step of performing the respective functionality. Likewise, any functionality described to be performed at or by the network orchestration function may imply the service orchestrator being configured to perform the respective functionality or the corresponding method to comprise a step of performing the respective functionality. Any functionality described without specific reference to the network orchestration function, or the service orchestrator may be performed by the network orchestration function or the service orchestrator or both jointly.

In an embodiment, the external control endpoint may be an external endpoint of a virtualized infrastructure manager (VIM) of the private cloud environment. Using such a virtualized infrastructure manager, the telecommunications network may control the subdomain, for example to deploy the one or more network functions.

In an embodiment, the processing subsystem may be configured to provide information comprising or indicative of an external connectivity endpoint of the subdomain to the network orchestration function to enable the network orchestration function to establish connectivity between the one or more deployed network functions in the subdomain and one or more other network functions in the telecommunications network using the external connectivity endpoint.

In a further aspect of the invention, a system may be provided comprising a network node or system of network nodes implementing the network orchestration function as described in this specification and a network node or system of network nodes implementing the service orchestrator as described in this specification.

It will be appreciated by those skilled in the art that two or more of the above-mentioned embodiments, implementations, and/or aspects of the invention may be combined in any way deemed useful.

Modifications and variations of any one of the systems or devices (e.g., network nodes or systems of network nodes, network functions, etc.), computer-implemented methods, and/or computer programs, which correspond to the described modifications and variations of another one of these systems or devices, computer-implemented methods, and/or computer programs, or vice versa, may be carried out by a person skilled in the art on the basis of the present description.

### BRIEF DESCRIPTION OF THE DRAWINGS

These and other aspects of the invention are apparent from and will be elucidated with reference to the embodiments described hereinafter. In the drawings,

FIG. 1 shows an on-premises network which hosts a private cloud environment and a telecommunication network which provides connectivity to local devices in, at or near the on-premises network, with data communication between the local devices and an application instantiated in the private cloud environment taking place via a user plane of the telecommunications network;

FIG. 2 illustrates the service orchestrator in the private cloud environment and the network function virtualization orchestration in the telecommunications network, while showing interfaces between the orchestrators and the VIM and WIM;

FIG. 3 shows a subdomain provided in the private cloud environment, which subdomain comprises an external control endpoint for external control of the subdomain, at least one external application endpoint to a local application in the private cloud environment, and external access endpoints to remote radio units;

FIG. 4 illustrates the deployment of network functions from the telecommunications network to the subdomain to provide local connectivity between local devices connected to the remote radio units and the local application(s);

FIG. 5 illustrates a multi-site private cloud which is distributed over two on-premises networks, in which local connectivity is provided between the local devices connected to remote radio units at each premises and locally instantiated applications;

FIG. 6 shows a processor system which may be exemplary for a network node or system of network nodes configured to implement a network function;

FIG. 7 shows a non-transitory computer-readable medium comprising data;

FIG. 8 shows an exemplary data processing system.

It should be noted that items which have the same reference numbers in different figures, have the same structural features and the same functions, or are the same signals. Where the function and/or structure of such an item has been explained, there is no necessity for repeated explanation thereof in the detailed description.

### REFERENCE SIGNS LIST

The following list of references and abbreviations is provided for facilitating the interpretation of the drawings and shall not be construed as limiting the claims.
AMF access and mobility management function
APP application
BSS business support system
gNB-CU gNodeB centralized unit
gNB-DU gNodeB distributed unit
MANO management and orchestration
NFV network function virtualization
NFVO NFV-orchestrator
RRU remote radio unit
SMF session management function
SO service orchestrator
UPF user plane function
VIM virtual infrastructure manager
WIM wide area infrastructure manager
1-3 messages/steps in information exchange
100, 102 on-premises network
110 private cloud environment
120 subdomain in private cloud environment
130 external connectivity endpoint
140, 142 external access endpoint
150 external application endpoint
200 telecommunications network
210 network cloud environment
300 remote radio unit
310 remote radio unit in/at/near premises
320 device
350 application repository
360 network function repository
400 data exchange between device and application
410, 412 data exchange between device and application
500 processor system representing network function
510 network interface
520 processing subsystem
530 data storage
600 computer-readable medium
610 non-transitory data
1000 exemplary data processing system
1002 processor
1004 memory element
1006 system bus
1008 local memory
1010 bulk storage device
1012 input device
1014 output device
1016 network adapter
1018 application

### DESCRIPTION OF EMBODIMENTS

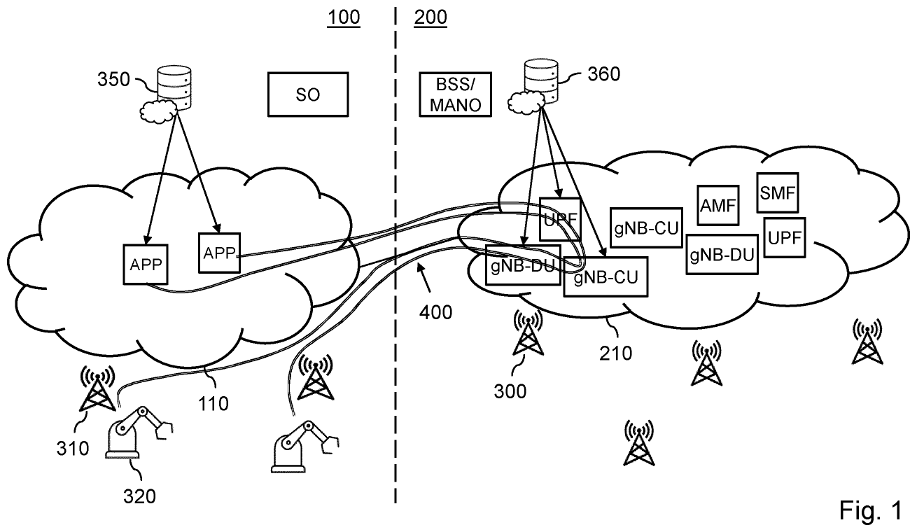

The following embodiments are described in the context of a telecommunications network adhering to one or more ETSI NFV and related standards, such as [3]. However, the concepts described in the following embodiments may equally apply, mutatis mutandis, to any other type of telecommunications network which provides connectivity to devices and which supports instantiation of network functions to support user plane communication between devices and applications. FIG. 1 shows an on-premises network 100 which hosts a private cloud environment 110. Such an on-premises network 100 may for example be installed on the premises of an enterprise, for example in a factory, a campus, an office building, etc. In the private cloud environment 110, applications APP may be instantiated by a service orchestrator SO. Such a service orchestrator may for example be based on the network function virtualization orchestrator as defined in [3] but may be (re) configured to support instantiation and management of applications and/or services of the enterprise. This respect, it is noted that an application typically provides a service to a device, and thus that the term application and service may be used interchangeably in this specification. The private cloud environment 110 may in general be managed by a virtualized infrastructure manager (VIM), which is not shown explicitly in FIG. 1, but which may be used by the service orchestrator SO to manage and control the virtual resources. Such applications APP may for example be instantiated from an application repository 350, for example an application repository hosted on the on-premises network 100 or outside of the network, e.g., on the Internet. Non-limiting examples of such repositories are GitHub and Docker Hub Container Image Library (Docker Hub).

FIG. 1 further shows devices 320 which may seek to access the applications APP instantiated in the private cloud environment 110. In the example of FIG. 1, the devices 320 are shown to be robotic arms which may be installed on-premises, e.g., in the factory. However, for connectivity, the devices 320 may rely on a telecommunications network 200, which is in the following by way of example a 5G telecommunications network based on one or more ETSI NFV standards. The telecommunications network 200 may comprise a number of access points in the form of remote radio units (RRUs) 300, 310 for the devices 320 to connect to the telecommunications network 200. For sake of illustration, remote radio units 310 at or near the on-premises network 100 are shown in FIG. 1 at the side of the on-premises network 100 to illustrate their proximity to the on-premises network 100 while remote radio units 300 elsewhere shown at the side of the telecommunications network 200.

In the telecommunications network 200, a number of network functions may be instantiated in a cloud environment 210, for example from a network function repository 360, for example in form of the aforementioned GitHub or Docker Hub. Such network functions may include, but are not limited to, a session management function (SMF), an access and mobility management function (AMF), a user plane function (UPF), a gNodeB centralized unit (gNB-CU) and a gNodeB distributed unit (gNB-DU). Such network functions may be managed by a network function virtualization orchestrator (NFVO) [3], with the NFVO not being explicitly shown in in FIG. 1 but being in terms of functionality integrated into a network support system, such as a business support system (BSS) having management and orchestration (MANO) functionality.

There may be a desire for the enterprise's devices 320 to have access to the applications APP instantiated in the private cloud environment 110. For that purpose, the NFVO of the telecommunications network 200 may instantiate one or more network functions which support user plane communication and configure the one or more network functions to route application data traffic between the devices 320 and the applications APP via the instantiated network functions. In the example of FIG. 1, these network functions may be instances of the aforementioned UPF, gNB-CU and gNB-DU. Disadvantageously, depending on the distance and capability of the link between the on-premises network 100 and the telecommunications network 200, the performance may be limited. In addition, as also elucidated elsewhere in this specification, there may be other disadvantages to such routing of application data traffic between the enterprise's devices 320 and its applications APP.

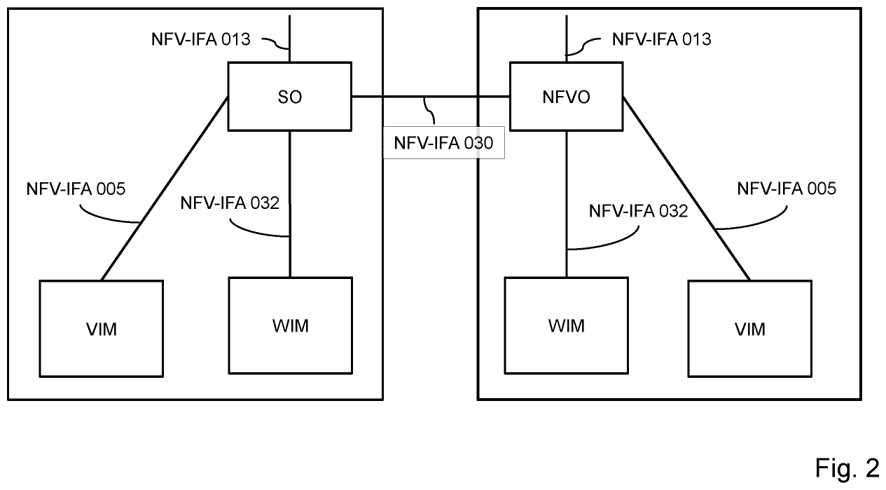

FIG. 2 further illustrates the service orchestrator SO in the private cloud environment and the network function virtualization orchestrator NFVO in the telecommunications network. The NFVO and SO may both be the orchestrators in their respective administrative domains, and may each have a service (interface) compliant with the NFV-IFA 013 specification to facilitate the following actions, which actions may be of relevance for their orchestration functionality as described in this specification:
NSD Management interface: this interface may be used to create, edit, and delete Network Service Descriptions (NSDs).
NS Lifecycle Management interface: this interface may be used to instantiate, modify, and delete Network Services (NSs).
NFVI Capacity Information interface: this interface may be used to query and get notifications about the resource capacity of the NFVI.

In addition, the NFVO and SO may both have a service interface compliant with the NFV-IFA 030 specification, which may be used for information exchanges between the NFVO and the SO in different administrative domains and may support a restricted set of actions from the NSD Management and NS Lifecycle Management interfaces as specified in NFV-IFA 013. The service interface may further provide authorization features to define entities and actions which can be taken on these interfaces.

Further shown in FIG. 2 is the virtualized infrastructure manager (VIM), this being a functional block which may represent cloud management and may offer services (interfaces) compliant with NFV-IFA 005, including but not limited to a software image management interface, virtualized compute interface, virtualized network interface, network forwarding path management interface and other interfaces that concern creating and managing virtual compute, network and storage resources. The VIM may effect changes to virtual resources, as for example requested by the NFVO or SO. Further shown in FIG. 2 is a wide area network infrastructure manager (WIM), this being a functional block that may implement functionalities to manage multi-site NFV infrastructure (NFVI) connectivity, named Multi Site Connectivity Services (MSCS), and which may offer a MSCS Management Service (interface) compliant with the NFV-IFA 032 specification that has operations to create, modify and terminate MSCSs. It is noted that the VIM, WIM, and the described service interfaces are known per se, while this specification describes modifications to be applied to known types of NFVO.

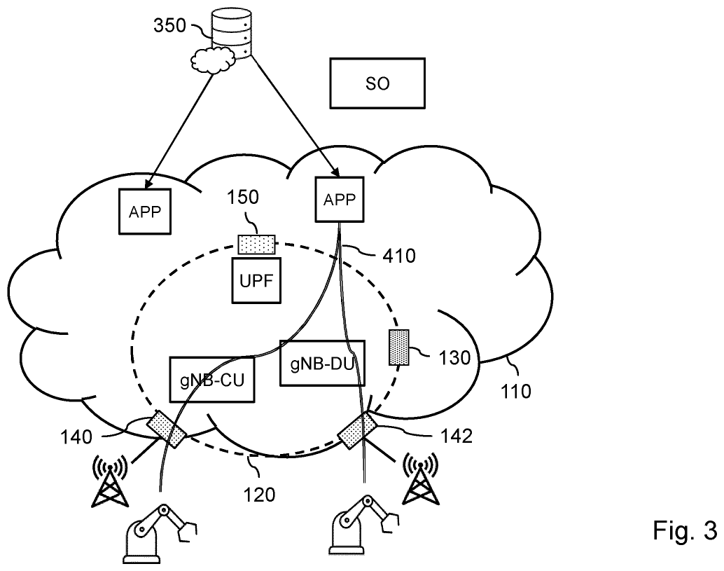

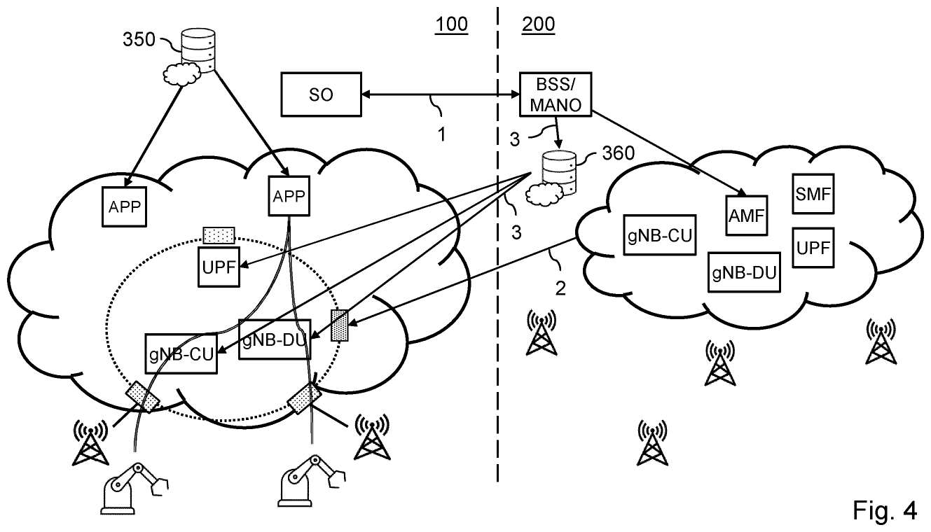

FIGS. 3 and 4 illustrate how the problem(s) elucidated with reference to FIG. 1 may be addressed, in that they illustrate how local connectivity between devices and applications may be established in a manner which may keep the administrative domains of the enterprise and the network operator separate. This may essentially involve providing a subdomain 120 in the private cloud environment 110 for use by the telecommunications network, which subdomain 120 may be considered as an extension of the telecommunications network and thereby a ‘network operator bubble’. The subdomain 120 may be established in any known manner, for example by manual configuration steps. FIG. 3 provides a more detailed view of the subdomain 120, while FIG. 4 shows how the subdomain may be used to establish the local connectivity between devices and applications. With continued reference to FIG. 3, the subdomain 120 may be established to have a number of external endpoints for various uses. These endpoints may include an external control endpoint, which is not explicitly shown in FIG. 3 but which may allow the subdomain 120 to be managed by the telecommunications network, an external connectivity endpoint 130, external access endpoints 140, 142 and an external application endpoint 150. Such endpoints may take various forms, including but not limited to HTTP URL, IP Address, Network name, etc.

The local connectivity between devices and applications may for example be established in three high-level steps, which steps may also be illustrated in FIG. 4 by corresponding reference numerals 1-3. In a first step 1, the service orchestrator SO may send a virtualized infrastructure management (VIM) object representing the subdomain from the private cloud environment to the network operator's NFVO. Here, the term ‘object’ may refer to structured data which may be used to characterize the virtualized infrastructure provided in or by the subdomain. In particular, the data may contain information necessary for the NFVO to be able to control the subdomain. The VIM object may be provided by the SO to the NFVO either directly, or by providing the VIM object to the network operator's BSS. Upon receiving the VIM object, the NFVO may provision the subdomain to its list of virtual infrastructures (VIMs). Aside from the VIM object, the SO may also inform the NFVO of connectivity constraints, for example by providing an application description to the NFVO. The application description may for example be indicative of where network functions are to be connected to the private cloud environment, e.g., by listing an external application endpoint, external access endpoint or external connectivity endpoint. In a second step 2, the NFVO may set up wide area network connectivity between the subdomain and the telecommunication network's cloud environment using the subdomain's external connectivity endpoint. In a third step 3, the NFVO may deploy network functions in the subdomain, being in this case instances of the UPF, gNB-CU and gNB-DU. The configuration and deployment parameters of the network functions may for example be derived by the NFVO from the application description. By deploying the network functions, a type of federation may be established between the private cloud environment and the cloud environment in the telecommunications network, which federation may have the specific goal of having the network functions optimally deployed, for example in terms of identifying the necessary network functions, the number of network functions and their configurations and their connectivity with respect to the applications and devices in the enterprise.

The above steps may be again explained with the following more detailed example. An enterprise may have a private cloud environment with deployed applications and devices, which private cloud environment may be orchestrated by the service orchestrator. The enterprise may also have remote radio units (RRUs) installed on-premises, which RRUs may be compatible with the gNB-DU function of the network operator. The NFVO may have a service catalog containing an enterprise networking service, with said service being comprised of the UPF, gNB-DU and gNB-CU and being instantiable via a NFVO API service operation, or if access to the BSS of the network operator is available, via an API of the BSS. While the UPF, gNB-DU and gNB-CU may not form a completely functioning 5G telecommunications system, these network functions may remain connected to other network functions in the telecommunications network so as to form this completely functioning 5G telecommunications system.

Once the applications have been deployed in the private cloud environment, a management function of the SO may initiate the following procedure:

1. The SO may send a VIM management object to the NFVO, with said object containing information for the NFVO to connect and manage the VIM of the subdomain in the private cloud environment. This information may include an endpoint where the VIM may be reached by the NFVO to control the subdomain, which endpoint may elsewhere also be referred to as an external control endpoint. The information may in some examples further include a VIM (cloud) type and a generated tenant ID for the network operator. The information may some examples further include a WAN connectivity object to describe an external connectivity endpoint of the subdomain. This WAN connectivity object may be any type of networking information that may be used to establish the connectivity between cloud environments, such as a MscsData object as specified in NFV-IFA 032, an IP address of a virtual private network (VPN) server, an API endpoint of a software defined network (SDN) controller that controls the enterprise SD-WAN gateway or an API endpoint of the enterprise's network service (NS).

2. The NFVO may use the VIM management object to provision a new VIM in its list of possible deployment targets. The NFVO may also contact its WIM while providing for example the MscsData received from the SO to the WIM using the MSCS Management Interface Create MSCS operation in order to establish the connectivity between the cloud environments. The NFVO may respond to the SO with a reference to the created VIM and WIM objects so the SO may refer to the VIM and WIM later on.

3. The SO may send an NS Instantiation request to instantiate the aforementioned enterprise networking service. In this request, the SO may refer to the VIM and WIM objects received in step 2, as well as provide an application description of the factory service in the form of a list of external endpoints of the subdomain. These endpoints may include access endpoints, application endpoints and connectivity endpoints. The access endpoints may be endpoints facing the remote radio units, the application endpoints may be endpoints facing the application or services, and the connectivity endpoints may be endpoints facing the telecommunications network. The endpoints may for example be network names, IP addresses or any other reference which is indicative of to where the application, RRUs and/or core functions may connect. In general, the endpoints may be accessible for the provided tenant.

4. When receiving this request, the NFVO may initiate the deployment of network functions to the subdomain, for example from a network function repository. The NFVO may for example deploy an UPF to be connected to the external application endpoint in order to be able to break out traffic locally, at least one gNB-CU and gNB-DU to be connected to the external access endpoints and at least one gNB-CU and UPF to be connected to the external connectivity endpoint, for example for the N2, N4 and N9 3GPP interfaces. During the deployment, aside from deriving configuration for the network functions deployed in the subdomain, other network functions in the telecommunications network may be reconfigured in order to interact with the newly deployed network functions in the subdomain. For that purpose, the NFVO or the OSS may initiate the setup of an N4 interface between the UPF (in the private cloud environment) and the SMF (in the network operator's cloud environment), as well as N2 interface between the gNB-CU (in the private cloud environment) and the AMF (in the network operator's cloud environment).

In general, devices may need to authenticate with, and receive authorization from, a telecommunications network. When the device identifiers are known and provisioned in the network operator's UDM, standard procedures may be used. However, if the devices use a specific network slice, this authentication and authorization may be based on custom enterprise credentials. In cases involving a vast number of devices, as for example in the case of an enterprise, the provisioning of these credentials may be automated with onboarding. So-called onboarding procedures may be known from 3GPP where a network function (SMF) may send an FQDN/IP address of a provisioning server to the device, and the device may fetch its credentials from the provisioning server (e.g., as specified in 3GPP TS 23.501, clause 5.39) by using a specific type of onboarding PDU Session. Since the enterprise may be the owner of the provisioning server, the SO may provide the network address of provisioning server to the NFVO as part of the ‘Instantiate NS request in step 3. The NFVO or OSS may then include these network addresses in the reconfiguration of the SMF in step 4 so that when an onboarding PDU Session is later established by any device of the enterprise, this network address may be delivered to the device.

With continued reference to the RRUs used by devices for their connectivity: such RRUs may be physically connected to the enterprise infrastructure, while virtual networking resources (in the form of external access endpoints) may be used to connect a RRU to the gNB-DU deployed in the subdomain. However, there may be cases when the enterprise may also need or wish to use one or more of the network operator's RRUs. This may be due to operational cost reasons or due to less stringent requirements where more infrastructure sharing is possible (effectively also lowering cost). In some embodiments, the SO may in step 1 provide an additional WAN connectivity object to the NFVO, which additional WAN connectivity object may identify a geographical location or area in which the devices may be located. This additional WAN connectivity object may be forwarded by the NFVO to the WIM to establish a second connection in step 2 between the enterprise and the network operators RRUs.

In some embodiments, whenever the subdomain is established and the network functions are deployed, a specific set of features may be exposed to the enterprise in order to allow the enterprise to exercise more detailed control of its connectivity. An example of a feature is QoS control, which the enterprise may integrate in its own applications to provide full stack control without having to operate a telecommunications network. Another example is the more general policy control, where not just QoS may be controlled, but also other policy-related aspects such as local breakouts, application detection, filtering, etc. These features may be made available by the PCF function in the 5G system. The service to use the features may be specified in TS 23.502 clause 5.2.5.3 Npcf_PolicyAuthorization Service and 5.2.5.8 Npcf_AMPolicyAuthorization Service: these are APIs that may be called in order to change policies for specific devices. In order to support this for the enterprise network, in the NS Instantiate request, the SO may provide a feature request “Policy Control” in step 3 as an information element. If the NFVO receives this information element in the request message, in step 4 after the (re) configuration of the network functions (which may include the aforementioned PCF), the NFVO may provide an API endpoint in the form of an FQDN or an IP address where enterprise applications may access the Npcf_PolicyAuthorization and Npcf_AMPolicyAuthorization services.

In cases with (extremely) stringent service requirements, performance of network functions may be imperative for good service delivery. However, when using network functions deployed in the subdomain, the resource targets that a network function may need to achieve to meet certain key performance indicators (KPIs), such as throughput and latency, may not be checked. In order to support such checks, before the deployment of the network functions to the subdomain, the NFVO may check the capacity of the subdomain, e.g., in terms of compute resources, network throughput, etc., using the service orchestrator SO's NFVI Capacity Information service, Query NFVI capacity service operation. To enable the NFVO to check the aforementioned capacity, the NFVI Capacity Information service may be authorized for use by the SO interface. In case the capacity is lower than all the network function's resource targets, the NFVO may decide not to deploy the network functions to the subdomain.

With continued reference to the NFVO configuring the one or more deployed network functions with the external application endpoint and the external access endpoint, the following is noted. The endpoints may be used both by the NFVO to (re) configure the one or more deployed network functions, and for the user plane communication to be established later on, e.g., at the request of the device. Namely, when a connection request (e.g., PDU Session Establishment Request, which may trigger a control plane procedure to establish a PDU Session for the device) is sent from the device via the AMF to the SMF, the SMF may select the UPF in the subdomain and instruct, and thereby configure, the UPF to forward packets from the device to the application, and vice versa, via the external application endpoint. Likewise, the gNB-CU/DU may be instructed, and thereby configured, to forward packets to and from the device via the external access endpoint. In addition, the access point may be reconfigured to add a rule to forward packets for the device via the external access endpoint. In general, the (re) configuration of the one or more deployed network functions may comprise establishing interface(s) towards the application (usually called N6 in 3GPP specs) and towards the access point.

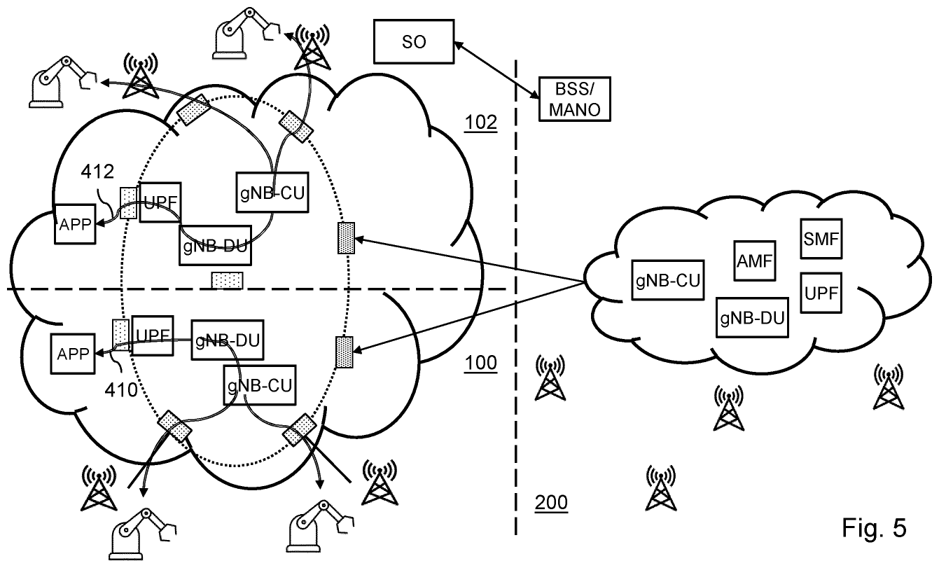

FIG. 5 illustrates a multi-site private cloud which may be distributed over two on-premises networks 100, 102, and in which local connectivity may be established between devices connected to access points at each premises and locally instantiated applications. FIG. 5 may be further explained as follows: an enterprise may have multiple sites (e.g., factories, offices, stores, etc.), each with a computing infrastructure. Although these different sites may be managed by different management interfaces (e.g., VIMs), the sites may also be managed by a single management interface (e.g., VIM) to optimally benefit from having a private cloud environment. In the latter case, it may be beneficial to allow the subdomain also to be distributed, rather than having a single breakout, e.g., at the enterprise's central office. From a network perspective, this may mean that the connectivity between applications and devices may be established by deploying a UPF function at every application endpoint, at least one gNB-CU and gNB-DU per site if there is an access endpoint at this site, and to connect each site using a connectivity endpoint to the telecommunications network 200. The UPFs, and the SMF that may control the UPFs, may be configured with a different Data Network Access Identifier (DNAI) for each site so the SMF may select the appropriate UPF based on the device's location. For that purpose, the SO may provide a WIM object for each enterprise site in step 1 in order to establish connectivity between each site and the telecommunications network. Whenever the NFVO receives multiple WIM objects, the NFVO may forward the WIM object of each site to its own WIM and send a response to the SO as previously described with reference to step 2. In step 3, in the description of the factory service (e.g., in form of the aforementioned application description), the SO may include a list of connectivity endpoints per site. When receiving multiple lists, in step 4, the NFVO may deploy the network functions relative to the endpoints and the sites, meaning that a UPF may be deployed at each (or at least one) application endpoint and a gNB-DU may be deployed at each (or at least one) access endpoint, with said network functions being connected to at least one connectivity endpoint. For each site, the SO may perform the tasks as previously described in step 4 and may derive a configuration for each UPF at each site based on the site where the UPF is deployed. For the example, as illustrated in FIG. 5, the UPF at site 1 (e.g., at on-premises network 100) may be configured with DNAI 1 and the UPF at site 2 (e.g., at on-premises network 102) may be configured with DNAI 2. This configuration may also be used for the SMF(s) controlling the UPFs so that the SMF may perform UPF selection for each of the devices based on the device's location, meaning for site 1 DNAI 1 and for site 2 DNAI 2. As a result, application data traffic 410 between devices and applications at site 1, and application data traffic 412 between devices and applications at site 2, may each be routed locally.

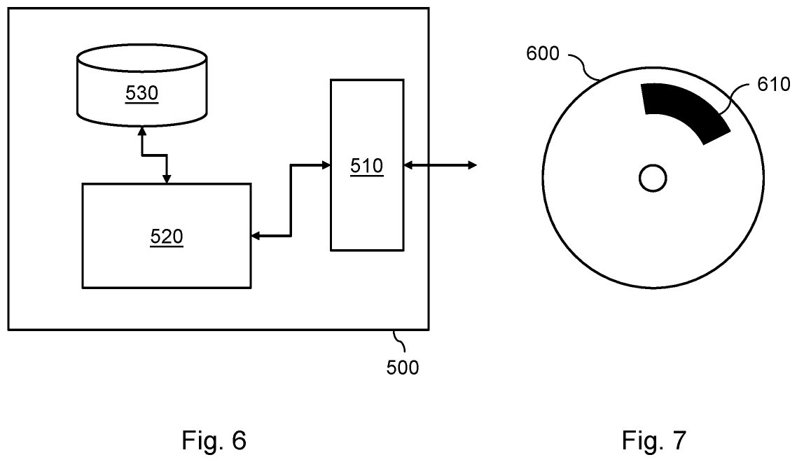

FIG. 6 shows a processor system 500 which may represent a network node or system of network nodes configured to provide an instance of a network function (e.g., the SO or NFVO or BSS/MANO) described in this specification, meaning that the processor system 500 may implement such a network function. The processor system 500 may comprise a network interface 510 for network data communication. The network interface 510 may for example be a wired communication interface, such as an Ethernet or fiber-optic based interface, to a fixed (e.g., non-mobile) part of a mobile telecommunications network. Alternatively, the network interface 510 may be a wireless communication interface. In yet other examples, the processor system 500 may be a subsystem of a larger system, e.g., a supra-system implementing several network functions. In such cases, the network interface 510 may be an internal interface of the supra-system, for example a virtual, software-based network interface.

The processor system 500 may further comprise a processing subsystem 520 which may be configured, e.g., by hardware design or software, to perform the operations described in this specification in as far as pertaining to the entity that the processor system is embodying, e.g., the network node or system of network nodes implementing the network function. In general, the processing subsystem 520 may be embodied by a single Central Processing Unit (CPU), such as a x86 or ARM-based CPU, but also by a combination or system of such CPUs and/or other types of processing units. In embodiments where the processor system 500 is distributed over different entities, e.g., over different servers, the processing subsystem 520 may also be distributed, e.g., over the CPUs of such different servers. As also shown in FIG. 6, the processor system 500 may comprise a data storage 530, such as a hard drive, a solid-state drive, or an array of such hard and/or solid-state drives, etc., which may be used to store data. In some examples, the processor system 500 may be implemented by a network node, or by a system of network nodes jointly providing the network function.

In general, each entity described in this specification may be embodied as, or in, a device or apparatus. The device or apparatus may comprise one or more (micro) processors which execute appropriate software. The processor(s) of a respective entity may be embodied by one or more of these (micro) processors. Software implementing the functionality of a respective entity may have been downloaded and/or stored in a corresponding memory or memories, e.g., in volatile memory such as RAM or in non-volatile memory such as Flash. Alternatively, the processor(s) of a respective entity may be implemented in the device or apparatus in the form of programmable logic, e.g., as a Field-Programmable Gate Array (FPGA). Any input and/or output interfaces may be implemented by respective interfaces of the device or apparatus. In general, each functional unit of a respective entity may be implemented in the form of a circuit or circuitry. A respective entity may also be implemented in a distributed manner, e.g., involving different devices or apparatus.

It is noted that any of the methods described in this specification, for example in any of the claims, may be implemented on a computer as a computer implemented method, as dedicated hardware, or as a combination of both. Instructions for the computer, e.g., executable code, may be stored on a computer-readable medium 600 as for example shown in FIG. 7, e.g., in the form of a series 610 of machine-readable physical marks and/or as a series of elements having different electrical, e.g., magnetic, or optical properties or values. The executable code may be stored in a transitory or non-transitory manner. Examples of computer-readable mediums include memory devices, optical storage devices, integrated circuits, servers, online software, etc. FIG. 7 shows by way of example an optical storage device 600.

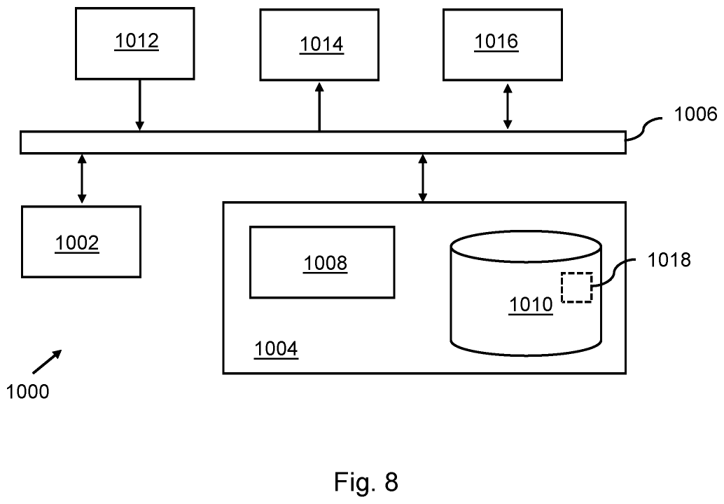

FIG. 8 is a block diagram illustrating an exemplary data processing system 1000 that may be used in the embodiments described in this specification. Such data processing systems include data processing entities described in this specification, including but not limited to a network node or system of network nodes implementing a network function (e.g., the SO or NFVO or BSS/MANO). The data processing system 1000 may include at least one processor 1002 coupled to memory elements 1004 through a system bus 1006. As such, the data processing system may store program code within memory elements 1004. Furthermore, processor 1002 may execute the program code accessed from memory elements 1004 via system bus 1006. In one aspect, data processing system may be implemented as a computer that is suitable for storing and/or executing program code. It should be appreciated, however, that data processing system 1000 may be implemented in the form of any system including a processor and memory that is capable of performing the functions described within this specification. The memory elements 1004 may include one or more physical memory devices such as, for example, local memory 1008 and one or more bulk storage devices 1010. Local memory may refer to random access memory or other non-persistent memory device(s) generally used during actual execution of the program code. A bulk storage device may be implemented as a hard drive, solid state disk or other persistent data storage device. The data processing system 1000 may also include one or more cache memories (not shown) that provide temporary storage of at least some program code in order to reduce the number of times program code is otherwise retrieved from bulk storage device 1010 during execution.

Input/output (I/O) devices depicted as input device 1012 and output device 1014 optionally can be coupled to the data processing system. Examples of input devices may include, but are not limited to, for example, a microphone, a keyboard, a pointing device such as a mouse, a game controller, a Bluetooth controller, a VR controller, and a gesture-based input device, or the like. Examples of output devices may include, but are not limited to, for example, a monitor or display, speakers, or the like. Input device and/or output device may be coupled to data processing system either directly or through intervening I/O controllers. A network adapter 1016 may also be coupled to data processing system to enable it to become coupled to other systems, computer systems, remote network devices, and/or remote storage devices through intervening private or public networks. The network adapter may comprise a data receiver for receiving data that is transmitted by said systems, devices and/or networks to said data and a data transmitter for transmitting data to said systems, devices and/or networks. Radios, modems, cable modems, and ethernet cards are examples of different types of network adapter that may be used with data processing system 1000.

As shown in FIG. 8, memory elements 1004 may store an application 1018. It should be appreciated that data processing system 1000 may further execute an operating system (not shown) that can facilitate execution of the application. The application, being implemented in the form of executable program code, can be executed by data processing system 1000, e.g., by processor 1002. Responsive to executing the application, the data processing system may be configured to perform one or more operations to be described herein in further detail.

For example, data processing system 1000 may represent a network node or system of network nodes as described in this specification. In that case, application 1018 may represent an application that, when executed, configures data processing system 1000 to perform the functions described with reference to the network node or the system of network nodes. In another example, data processing system 1000 may represent an embodiment of a network function (e.g., SO or NFVO or BSS/MANO) as described in this specification. In that case, application 1018 may represent an application that, when executed, configures data processing system 1000 to perform the functions described with reference to the network function.

An abstract for the present specification may read as follows: Network functions may be described to establish local connectivity between a device of a telecommunications network and an application instantiated a private cloud environment. The local connectivity may be established by providing, in the private cloud environment, a subdomain for use by the telecommunications network, wherein the subdomain may be manageable via an external control endpoint. A network orchestration function of the telecommunications network may, based on information received from a service orchestrator for the private cloud environment, initiate deployment of one or more network functions in the subdomain of the private cloud environment, and configure the one or more deployed network functions to allow the user plane communication between the device and the application to be established. Such local connectivity may be advantageous in terms of performance and address privacy and control concerns, which may otherwise occur if the application data traffic between the device and the application is routed via a core network of the telecommunications network.

It should be noted that the above-mentioned embodiments illustrate rather than limit the invention, and that those skilled in the art will be able to design many alternative embodiments without departing from the scope of the appended claims.

In the claims, any reference signs placed between parentheses shall not be construed as limiting the claim. Use of the verb “comprise” and its conjugations does not exclude the presence of elements or stages other than those stated in a claim. The article “a” or “an” preceding an element does not exclude the presence of a plurality of such elements. Expressions such as “at least one of” when preceding a list or group of elements represent a selection of all or of any subset of elements from the list or group. For example, the expression, “at least one of A, B, and C” should be understood as including only A, only B, only C, both A and B, both A and C, both B and C, or all of A, B, and C. The invention may be implemented by means of hardware comprising several distinct elements, and by means of a suitably programmed computer. In the device claim enumerating several means, several of these means may be embodied by one and the same item of hardware. The mere fact that certain measures are recited in mutually different dependent claims does not indicate that a combination of these measures cannot be used to advantage.

1. A network node or system of network nodes configured to implement a network orchestration function in a telecommunications network to assist in establishing local connectivity between a device and an application via a private cloud environment, wherein the application is instantiated in the private cloud environment, wherein the device is capable of connecting to the telecommunications network and communicating via a user plane of the telecommunications network, wherein the network node or system of network nodes comprises:
a network interface;
a processing subsystem configured to, via the network interface:
receive, from a service orchestrator in the private cloud environment, information which comprises or is indicative of:
an external control endpoint of a subdomain provided in the private cloud environment, wherein the subdomain is manageable via the external control endpoint;
an external application endpoint provided in the subdomain for the application in the private cloud environment; and
an external access endpoint provided in the subdomain for the device;
initiate deployment of one or more network functions in the subdomain of the private cloud environment using the external control endpoint, thereby obtaining one or more deployed network functions, wherein the one or more deployed network functions support user plane communication between the device and the application via the subdomain; and
configure the one or more deployed network functions using the external application endpoint and the external access endpoint to allow the user plane communication between the device and the application to be established via the one or more deployed network functions.

2. The network node or system of network nodes according to claim 1, wherein the processing subsystem is configured to:
receive, from the service orchestrator, information comprising or indicative of an external connectivity endpoint of the subdomain;
establish connectivity between the one or more deployed network functions in the subdomain and one or more other network functions in the telecommunications network using the external connectivity endpoint.

3. The network node or system of network nodes according to claim 2, wherein the processing subsystem is configured to establish the connectivity between the one or more deployed network functions in the subdomain and the one or more other network functions in the telecommunications network by requesting a wide area network infrastructure manager (WIM) of the telecommunications network to collaboratively establish said connectivity in collaboration with a wide area network infrastructure manager (WIM) of the private cloud environment.

4. The network node or system of network nodes according to claim 2, wherein the one or more other network functions include at least one of:
a session management function (SMF); and
an access and mobility management function (AMF).

5. The network node or system of network nodes according to claim 1, wherein the device is configured to connect to a remote radio unit (RRU) of the telecommunications network, wherein the processing subsystem is configured to establish connectivity between the remote radio unit and the external access endpoint of the subdomain to enable the device to connect to the subdomain via the remote radio unit.

6. The network node or system of network nodes according to claim 5, wherein the processing subsystem is configured to establish the connectivity between the remote radio unit and the external access endpoint of the subdomain using a wide area network infrastructure manager (WIM) of the telecommunications network.

7. The network node or system of network nodes according to claim 5, wherein the processing subsystem is configured to:
receive, from the service orchestrator, geolocation information indicative of a geolocation of the device; and
identify between which remote radio unit and the external access endpoint connectivity is to be established by, based on the geolocation information, identifying a remote radio unit which is in a geographical vicinity of the device.

8. The network node or system of network nodes according to claim 1, wherein the processing subsystem is configured to:
receive, from the service orchestrator, a request for policy control;
in response to the request, expose one or more policy control functions of the telecommunications network to be accessed from the private cloud environment.

9. The network node or system of network nodes according to claim 1, wherein the one or more deployed network functions include at least one of:
a user plane function (UPF); and
a gNodeB centralized unit (gNB-CU) function; and
a gNodeB distributed unit (gNB-DU) function.

10. The network node or system of network nodes according to claim 1, wherein the network orchestration function implemented by the network node or system of network nodes is a network functions virtualization orchestrator (NFVO) or a combination of the network functions virtualization orchestrator and a network support system (OSS/BSS).

11. A network node or system of network node configured to implement a service orchestrator for a private cloud environment, wherein the service orchestrator is configured to assist in establishing local connectivity between a device and an application via the private cloud environment, wherein the application is instantiated in the private cloud environment, wherein the device is capable of connecting to a telecommunications network and communicating via a user plane of the telecommunications network, the network node or system of network nodes comprising:
a network interface;
a processing subsystem configured to, via the network interface, provide information to a network orchestration function in the telecommunications network, wherein the information comprises or is indicative of:
an external control endpoint of a subdomain provided in the private cloud environment, wherein the subdomain is manageable via the external control endpoint;
an external application endpoint provided in the subdomain for the application in the private cloud environment; and
an external access endpoint provided in the subdomain for the device;
to enable the network orchestration function to initiate deployment of one or more network functions in the subdomain of the private cloud environment using the external control endpoint, thereby obtaining one or more deployed network functions, wherein the one or more deployed network functions support user plane communication between the device and the application via the subdomain, and to configure the one or more deployed network functions using the external application endpoint and the external access endpoint to allow the user plane communication between the device and the application to be established via the one or more deployed network functions.

12. The network node or system of network node according to claim 11, wherein the external control endpoint is an external endpoint of a virtualized infrastructure manager (VIM) of the private cloud environment.

13. The network node or system of network node according to claim 11, wherein the processing subsystem is configured to provide information comprising or indicative of an external connectivity endpoint of the subdomain to the network orchestration function to enable the network orchestration function to establish connectivity between the one or more deployed network functions in the subdomain and one or more other network functions in the telecommunications network using the external connectivity endpoint.

14. (canceled)

15. A computer-implemented method of assisting in establishing local connectivity between a device and an application via a private cloud environment, wherein the application is instantiated in the private cloud environment, wherein the device is capable of connecting to a telecommunications network and communicating via a user plane of the telecommunications network, wherein the method comprises, at a network node or a system of network nodes in the telecommunications network:
receiving, from a service orchestrator in the private cloud environment, information which comprises or is indicative of:
an external control endpoint of a subdomain provided in the private cloud environment, wherein the subdomain is manageable via the external control endpoint;
an external application endpoint provided in the subdomain for the application in the private cloud environment; and
an external access endpoint provided in the subdomain for the device;
initiating deployment of one or more network functions in the subdomain of the private cloud environment using the external control endpoint, thereby obtaining one or more deployed network functions, wherein the one or more deployed network functions support user plane communication between the device and the application via the subdomain; and
configuring the one or more deployed network functions using the external application endpoint and the external access endpoint to allow the user plane communication between the device and the application to be established via the one or more deployed network functions.

16. A computer-implemented method of assisting in establishing local connectivity between a device and an application via a private cloud environment, wherein the application is instantiated in the private cloud environment, wherein the device is capable of connecting to a telecommunications network and communicating via a user plane of the telecommunications network, wherein the method comprises, at a network node or a system of network nodes in a local area network which hosts the private cloud environment:
providing information to a network orchestration function in the telecommunications network, wherein the information comprises or is indicative of:
an external control endpoint of a subdomain provided in the private cloud environment, wherein the subdomain is manageable via the external control endpoint;
an external application endpoint provided in the subdomain for the application in the private cloud environment; and
an external access endpoint provided in the subdomain for the device;
to enable the network orchestration function to initiate deployment of one or more network functions in the subdomain of the private cloud environment using the external control endpoint, thereby obtaining one or more deployed network functions, wherein the one or more deployed network functions support user plane communication between the device and the application via the subdomain, and to configure the one or more deployed network functions using the external application endpoint and the external access endpoint to allow the user plane communication between the device and the application to be established via the one or more deployed network functions.

17. A transitory or non-transitory computer-readable medium comprising data representing a computer program, the computer program comprising instructions for causing a processor system to perform the method according to claim 15.

18. A method of establishing local connectivity between a device and an application via a private cloud environment, wherein the application is instantiated in the private cloud environment, wherein the device is capable of connecting to a telecommunications network and communicating via a user plane of the telecommunications network, comprising:
providing, in the private cloud environment, a subdomain for use by the telecommunications network, wherein the subdomain is provided with an external application endpoint for the application in the private cloud environment and with an external access endpoint for the device and is manageable via an external control endpoint;
by a service orchestrator in the private cloud environment,
providing information to a network orchestration function of the telecommunications network, which information comprises or is indicative of at least the external control endpoint, the external application endpoint and the external access endpoint;
by the network orchestration function:
initiating deployment of one or more network functions in the subdomain of the private cloud environment using the external control endpoint, thereby obtaining one or more deployed network functions, wherein the one or more deployed network functions support user plane communication between the device and the application via the subdomain;
configuring the one or more deployed network functions using the external application endpoint and the external access endpoint to allow the user plane communication between the device and the application to be established via the one or more deployed network functions.
